(19) United States
(12) Patent Application Publication
(10) Pub. No.: US 2020/0218202 A1
(43) Pub. Date: Jul. 9, 2020

(54) ELECTRONIC WATCH

(71) Applicant: SEIKO EPSON CORPORATION, Tokyo (JP)

(72) Inventor: Toshiyuki NOZAWA, Okaya-shi (JP)

(73) Assignee: SEIKO EPSON CORPORATION, Tokyo (JP)

(21) Appl. No.: 16/736,935

(22) Filed: Jan. 8, 2020

(30) Foreign Application Priority Data
Jan. 9, 2019 (JP) 2019-001708

(51) Int. Cl. G04B 47/06; G04G 21/04; G01C 21/08; G01S 19/45; G04R 20/02

(52) U.S. Cl. CPC G04B 47/065; G04G 21/04; G04R 20/02; G01S 19/45; G01C 21/08

(57) ABSTRACT

An electronic watch includes a pointer, a receiver (GPS receiver) configured to receive positional identification information for identifying a current location, a magnetic sensor, and a controller configured to acquire destination information indicating a position of a destination, identify a direction of the destination, based on the positional identification information, an output of the magnetic sensor, and the destination information, identify a distance to the destination, based on the positional identification information and the destination information, and display a direction of the destination with the pointer. The controller switches the pointer to a set hand movement operation when the identified distance a threshold value.

The present application is based on, and claims priority from JP Application Serial Number 2019-001708, filed Jan. 9, 2019, the disclosure of which is hereby incorporated by reference herein in its entirety.

### BACKGROUND

### 1. Technical Field

The present disclosure relates to an electronic watch.

### 2. Related Art

A known technique for performing navigation to a destination by using a pointer-type analog watch is disclosed in JP-A-2017-161251, for example. The analog electronic watch disclosed in JP-A-2017-161251 includes a pointer, a distance indicator hand, a global positioning system (GPS) receiver that receives a satellite signal transmitted from a GPS satellite as positional identification information, a magnetic sensor, and a control unit. Then, the control unit constituting the electronic watch determines a direction of a destination and a distance to the destination, based on the satellite signal received by the GPS receiver, an output of the magnetic sensor, and destination information indicating a position of the destination, points to the direction of the destination with the pointer, and displays the distance to the destination with the distance indicator hand.

However, in the electronic watch of JP-A-2017-161251, the direction of the destination and the distance to the destination are each indicated with the pointer, but there is a problem in that a state in which a user approaches or arrives at the destination and the like cannot be intuitively informed, to the user, as information related to numerical information being a distance.

### SUMMARY

An electronic watch according to the specification includes a pointer, a receiver configured to receive positional identification information for identifying a current location, a magnetic sensor, and a controller configured to acquire destination information indicating a position of a destination, identify a direction of the destination, based on the positional identification information, an output of the magnetic sensor, and the destination information, identify a distance to the destination, based on the positional identification information and the destination information, and display a direction of the destination with the pointer, where the controller switches an operation of the pointer to a set hand movement operation when the identified distance a threshold value.

The above-described electronic watch further includes a distance indicator hand, and the controller may display a distance to the destination with the distance indicator hand.

In the above-described electronic watch, the hand movement operation may be a forward or reverse reciprocating hand movement or a forward or reverse circling hand movement of the pointer.

In the above-described electronic watch, the controller may display, with the pointer, that a user approaches or arrives at the destination by switching the hand movement operation.

In the above-described electronic watch, the hand movement operation may include a plurality of hand movement operation patterns, and the controller may switch the hand movement operation pattern among the plurality of hand movement operation patterns in accordance with a distance from the current location to the destination.

In the above-described electronic watch, the controller may have a plurality of threshold values set in accordance with a distance from the current location to the destination, and switch to the hand movement operation pattern corresponding to each of the threshold values.

The above-described electronic watch further includes a notification unit, and the controller may make a notification by the notification unit when the identified distance the threshold value.

In the above-described electronic watch, the notification unit may be at least any of a sound output unit, a light emitter, and a vibrator.

### BRIEF DESCRIPTION OF THE DRAWINGS

FIG. 1 is a plan view schematically illustrating an electronic watch according to a first exemplary embodiment.

FIG. 2 is a schematic configuration diagram of a global positioning system (GPS) including the electronic watch.

FIG. 3 is a functional block diagram of the electronic watch according to the first exemplary embodiment.

FIG. 4 is a diagram illustrating an example of a correlation between a plurality of threshold values and a hand movement operation pattern corresponding to each of the plurality of threshold values.

FIG. 5 is a diagram illustrating a relationship between an error in position due to a distance between a current location and a destination and an error in azimuth angle.

FIG. 6 is a flowchart illustrating a point registration operation of the electronic watch according to the first exemplary embodiment.

FIG. 7 is a flowchart illustrating a navigation operation of the electronic watch according to the first exemplary embodiment.

FIG. 8 is a plan view illustrating an electronic watch according to a second exemplary embodiment.

FIG. 9 is a functional block diagram of the electronic watch according to the second exemplary embodiment.

FIG. 10 is a flowchart illustrating a navigation operation of the electronic watch according to the second exemplary embodiment.

FIG. 11 is a functional block diagram of an electronic watch according to a third exemplary embodiment.

FIG. 12 is a diagram illustrating an example of a destination management table.

### DESCRIPTION OF EXEMPLARY EMBODIMENTS

Exemplary embodiments according to the present disclosure will be described below with reference to the accompanying drawings. Note that, in the drawings, dimensions and a scale of each unit are different from actual dimensions and an actual scale as appropriate. Moreover, exemplary embodiments described below are suitable specific examples of the present disclosure, and various technically preferable limitations are applied, but the scope of the present disclosure is not limited to these modes unless it is specifically described in the following description to limit the present disclosure.

### First Exemplary Embodiment

1. Overview of Electronic Watch

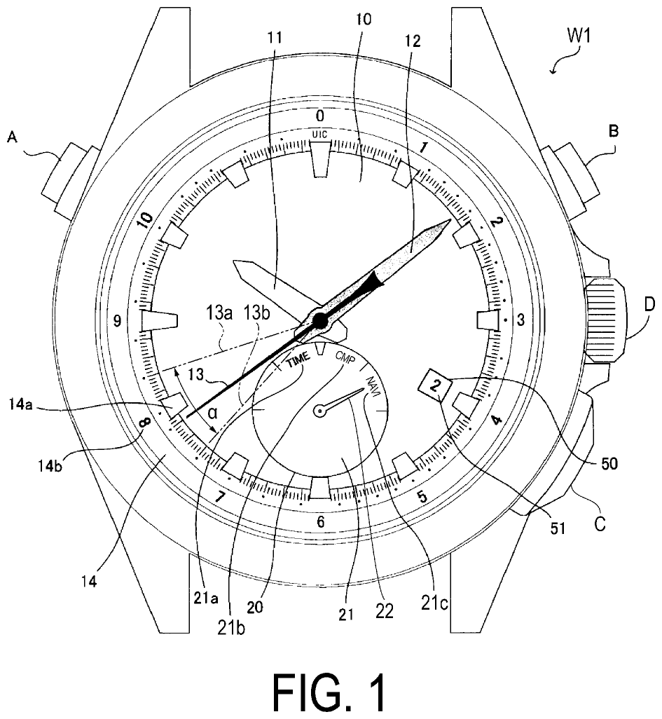

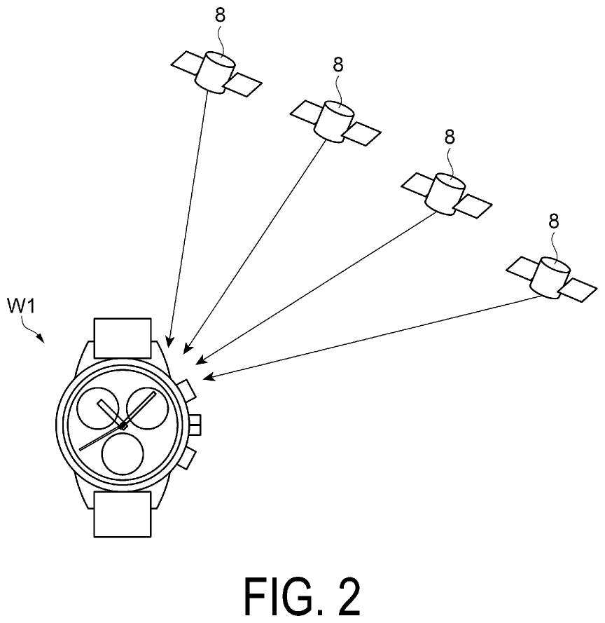

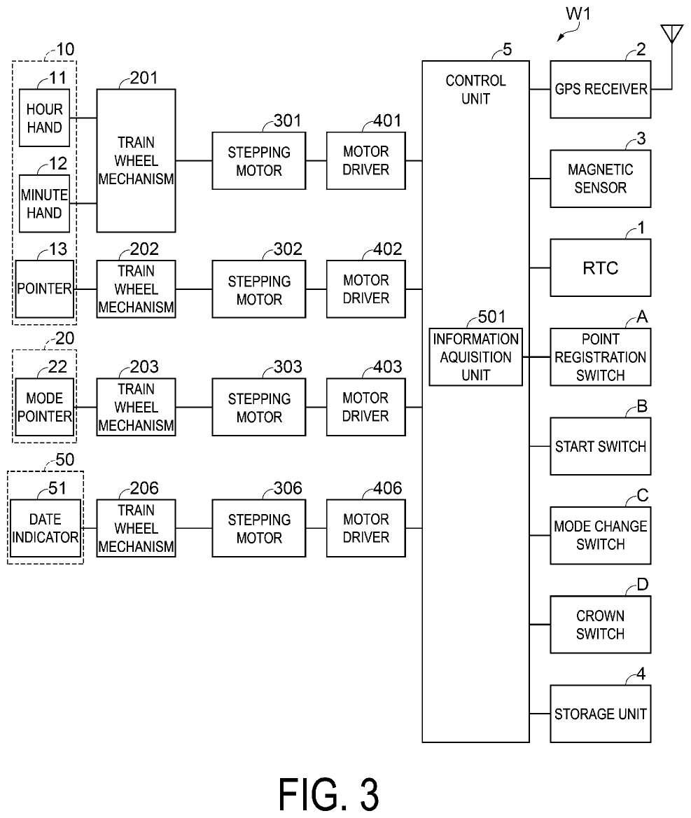

A configuration of an electronic watch according to a first exemplary embodiment will be described with reference to FIGS. 1, 2, and 3. The electronic watch according to the first exemplary embodiment is an electronic watch with a sensor. Note that, hereinafter, the electronic watch with the sensor will be described as an “electronic watch”. FIG. 1 is a plan view illustrating the electronic watch according to the first exemplary embodiment. FIG. 2 is a schematic configuration diagram of a global positioning system (GPS) including the electronic watch. FIG. 3 is a functional block diagram of the electronic watch according to the first exemplary embodiment.

Furthermore, an electronic watch W1 includes, as operation modes, a compass mode for displaying an azimuth, a navigation mode for performing navigation to a destination, and a time display mode for displaying time.

As illustrated in FIGS. 1, 2, and 3, the electronic watch W1 according to the first exemplary embodiment includes a time display unit 10, a point registration switch A, a start switch B, a mode change switch C, and a crown switch D. The time display unit 10 includes an hour hand 11, a minute hand 12, a pointer 13, a dial ring 14, a six o'clock-side information display unit 20 provided on a six o'clock side, and a date display unit 50.

A 12-hour scale 14a is formed annularly on the dial ring 14, and a scale 14b of 0 to 10 is formed annularly on an outer side of the scale 14a. When the operation mode is the time display mode, the time display unit 10 displays time with the hour hand 11 and the minute hand 12 with reference to the scale 14a. Further, when the operation mode is the navigation mode, the time display unit 10 can point to a direction of a destination with the pointer 13.

The six o'clock-side information display unit 20 includes a dial 21 and a mode pointer 22. A letter representing an operation mode is provided on the dial 21. Specifically, the dial 21 is provided with a letter 21a of “TIME” representing the time display mode, a letter 21b of “CMP” representing the compass mode, and a letter 21c of “NAVI” representing the navigation mode. Note that the electronic watch W1 can switch between the time display mode, the compass mode, and the navigation mode each time a user presses the mode change switch C.

1.1 Compass Mode

The electronic watch W1 can identify a north azimuth in the compass mode and display the identified north azimuth with the pointer 13. In the compass mode, the navigation start switch B and the mode change switch C are used.

1.1.1 Overview of Azimuth Identification Operation

When the user presses the mode change switch C, the electronic watch W1 can switch the operation mode into the compass mode. In the compass mode, a compass operation is started by the user pressing the start switch B. In the compass operation, an azimuth measurement using a magnetic sensor 3 is performed for a specific period of time after the start switch B is pressed, and a “north azimuth” is indicated by the pointer 13. Note that the specific period of time for which the azimuth measurement is performed may be, for example, 60 seconds, but can be changed as appropriate without being limited to 60 seconds.

For detailed description, in the compass operation, when the start switch B is pressed, the magnetic sensor 3 is activated and a measurement of a geomagnetic field is performed. A control unit 5 determines an orientation of the geomagnetic field within a horizontal plane from the measurement result of the geomagnetic field, and identifies the magnetic north. Note that, when a declination angle being a declination between the magnetic north and the due north is already determined, the control unit 5 corrects the magnetic north by the declination angle αnd determines the true north. Then, the control unit 5 controls a motor driver 402 and drives a stepping motor 302 such that the pointer 13 indicates a “north azimuth”.

1.2 Navigation Mode

The electronic watch W1 can perform navigation for returning from a current location to a departure point, for example, in the navigation mode. In this case, the departure point is a destination in the navigation. Hereinafter, a “departure point” may be described in different words as a “destination in navigation” or simply a “destination”. For the navigation, the point registration switch A, the start switch B, and the mode change switch C are used.

1.2.1 Overview of Point Registration Operation

In the compass mode, when the user continues to press the point registration switch A at a departure point for a specific period of time or longer, the electronic watch W1 performs a so-called position registration operation of acquiring coordinates of the departure point as position coordinates and holding the coordinates. The coordinates of the departure point having the position registered are used as coordinates of a destination in navigation. The coordinates of the destination are an example of destination information indicating a position of the destination. Note that the electronic watch W1 acquires the coordinates of the departure point by the GPS. Thus, the coordinates of the position are indicated by a latitude and a longitude. Note that the specific period of time for which the point registration switch A is continuously pressed may be, for example, two seconds, but can be changed as appropriate without being limited to two seconds. Further, the departure point at this time can be referred to as a current location, and further becomes a destination in the navigation after movement.

For detailed description, in the point registration operation, when a long press on the point registration switch A, for example, two seconds or longer is detected, the control unit 5 activates a GPS receiver 2 as a reception unit that receives positional identification information, receives a satellite signal as the positional identification information from a GPS satellite 8, and acquires position coordinates of a departure point, btased on the received satellite signal.

When the control unit 5 successfully acquires the position coordinates of the departure point, the control unit 5 ses the departure point as a destination in the navigation, and stores the position coordinates in a storage unit 4. Note that, in order to inform the user that the acquisition of the position coordinates of the departure point is successful, the control unit 5 may perform a hand movement operation of, for example, rotating the pointer 13 once in a clockwise direction when the acquisition of the position coordinates of the departure point is successful. Then, when the control unit 5 finishes setting the departure point as the destination in the navigation, the control unit 5 moves the mode pointer 22 of the six o'clock-side information display unit 20 such that the mode pointer 22 points to the letter 21c of “NAVI” representing the navigation mode. The user can be informed from the mode pointer 22 pointing to the letter 21c of “NAVI” representing the navigation mode that setting of the destination is completed and the navigation can start.

1.2.2 Overview of Navigation Operation

In the navigation operation, when the user moves to another point together with the electronic watch W1 after position setting of a departure point is performed by point registration, and the user then presses the mode change switch C, the operation mode of the electronic watch W1 switches. For example, when the user presses the mode change switch C in a case in which the operation mode is time display mode, the operation mode switches to the compass mode. Furthermore, when the user presses the mode change switch C in the compass mode, the compass mode switches to the navigation mode, and a standby state in which the navigation operation can start is set. Then, when the start switch B is continuously pressed for a predetermined period of time or longer in this standby state, the electronic watch W1 starts the navigation operation. Note that the predetermined period of time for a long press on the start switch B may be, for example, five seconds, but can be changed as appropriate without being limited to five seconds.

During the navigation operation, the electronic watch W1 acquires coordinates of a current location once or periodically by the GPS, and periodically acquires a north direction by using the magnetic sensor 3 described later. Each time the electronic watch W1 acquires coordinates of a current location by the GPS, the electronic watch W1 calculates a direction to a destination and a distance from a current location to the destination by using coordinates of the destination and the coordinates of the latest current location.

When calculating the direction of the destination and the distance to the destination, the electronic watch W1 performs navigation for returning to a departure point being the destination by pointing, with the pointer 13, to the direction of the destination with reference to the north direction acquired by using the magnetic sensor 3.

Further, when the electronic watch W1 calculates the direction of the destination as the departure point and the distance to the destination, the electronic watch W1 displays the distance to the destination with the hour hand 11 and the minute hand 12 with reference to the scale 14b. Then, when the distance to the destination a set threshold value, that is, when the user approaches the destination within a predetermined distance, the electronic watch W1 switches the hand movement operation of the pointer 13. When the user approaches the destination within the predetermined distance, as illustrated in FIG. 1, for example, the electronic watch W1 switches the pointer 13 to a hand movement operation of a reciprocating hand movement in forward and reverse directions between a line segment 13a and a line segment 13b that are assumed at an angle α with an azimuth position of the destination as the center, and causes the hand movement operation of the pointer 13. The electronic watch W1 displays, to the user, that the user approaches the destination within the predetermined distance by switching the hand movement operation of the pointer 13 to the reciprocating hand movement. Note that the reciprocating hand movement of the pointer 13 may include a plurality of hand movement operation patterns of hand movement operations at different angles α. Further, the hand movement operation of the pointer 13 herein is not limited to the reciprocating hand movement, and a hand movement operation different from normal hand movement, such as a forward or reverse circling hand movement and a fast-forward hand movement, for example, may be used.

Further, the electronic watch W1 has a plurality of threshold values set in accordance with a distance from a current location to a destination, and can switch to a hand movement operation pattern corresponding to each of the threshold values when the distance each of the threshold values. In other words, the electronic watch W1 includes a plurality of hand movement operation patterns set in accordance with a distance from a current location to a destination, and the plurality of hand movement operation patterns correspond to respective threshold values. Herein, a hand movement operation pattern of the hand movement operation of the pointer 13 is preset such that the hand movement operation is performed at a different angle α. Note that the “presetting” includes setting at the time of factory shipment, setting performed by the user, automatic setting performed by the electronic watch W1, and the like.

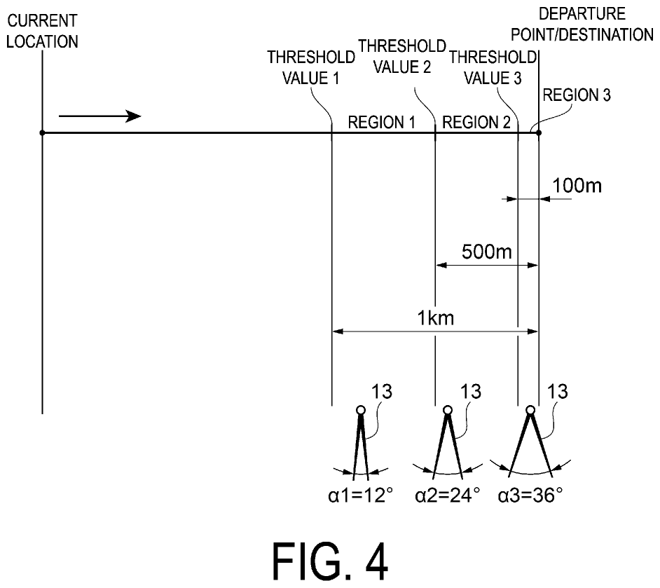

Hereinafter, a relationship between a plurality of threshold values set in accordance with a distance from a current location to a destination and a corresponding hand movement operation pattern will be described with reference to FIG. 4. FIG. 4 is a diagram illustrating an example of a correlation between a plurality of threshold values and a hand movement operation pattern corresponding to each of the plurality of threshold values.

As illustrated in FIG. 4, the electronic watch W1 sets, as threshold values related to a distance from a current location to a destination, “1 km” as a threshold value 1, “500 m” as a threshold value 2, and “100 m” as a threshold value 3, for example. Then, for example, when a distance to a destination “1 km” of the threshold value 1, that is, when the user enters a region 1 between the threshold value 1 and the threshold value 2, the electronic watch W1 causes, as a hand movement operation pattern corresponding to the threshold value 1, a reciprocating hand movement of the pointer 13 at an angle α1=12 degrees with an azimuth position of the destination as the center. Further, for example, when the distance to the destination “500 m” of the threshold value 2, that is, when the user further approaches the destination and enters a region 2 between the threshold value 2 and the threshold value 3, the electronic watch W1 causes, as a hand movement operation pattern corresponding to the threshold value 2, a reciprocating hand movement of the pointer 13 at an angle α2=24 degrees with the azimuth position of the destination as the center. Further, for example, when the distance to the destination

“100 m” of the threshold value 3, that is, when the user enters a region 3 between the threshold value 3 and the destination, the electronic watch W1 causes, as a hand movement operation pattern corresponding to the threshold value 3, a greatly reciprocating hand movement of the pointer 13 at an angle α3=36 degrees with the azimuth position of the destination as the center. In this way, by increasing a swinging angle of the reciprocating hand movement of the pointer 13 as the user approaches the departure point being the destination, the user can be informed about the extent of the distance to the destination.

Note that, when the pointer 13 functions as a seconds hand in the time display mode, one step becomes units of six degrees, and the angle α1, the angle α2, and the angle α3 can be referred to as one-step width, a two-step width, and a three-step width, respectively. Herein, a correspondence of a swinging angle of reciprocating motion of the pointer 13 with respect to a distance to a destination may be discretized according to a step of a hand movement of the pointer 13 after calculation with a function of the distance. For example, the swinging angle of the reciprocating motion may be set to 3600/L with respect to a distance L to a destination, and discarding may be performed by units of six degrees. In this case, for example, an angle is 12 degrees when a distance to a destination is 300 m, and an angle is 24 degrees when the distance is 150 m. Note that, when a distance to a destination exceeds 600 m, a swinging angle falls below six degrees and is discarded, and the pointer 13 does not reciprocate.

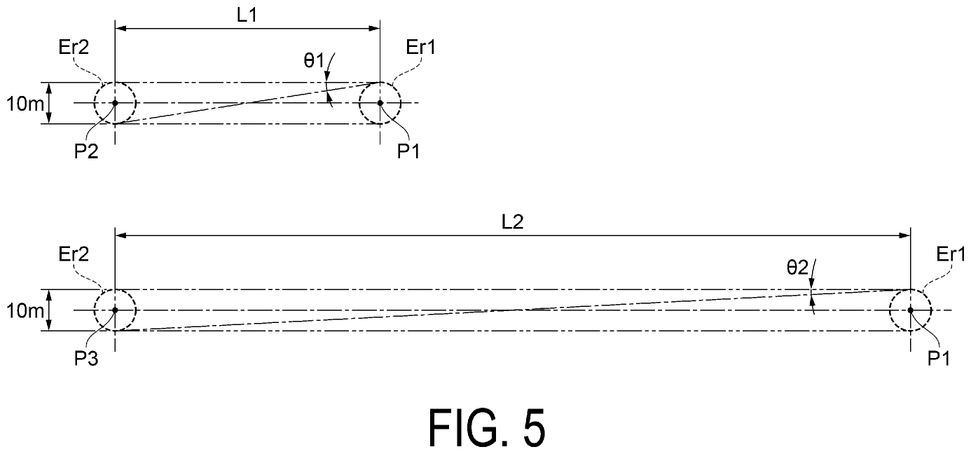

Further, by performing the display as described above, the electronic watch W1 can also inform the user about a state of an error in azimuth of a destination caused by a GPS error. This point will be described below with reference to FIG. 5. FIG. 5 is a diagram illustrating a relationship between an error in position due to a distance between a current location and a destination and an error in azimuth angle.

There is a certain error in a position measurement by the GPS, and the error appears as an error in azimuth when an azimuth from a current location to a destination is calculated. For example, when errors in positions of a destination and a current location are identically 10m as illustrated in FIG. 5, appearing errors in azimuth vary by distances L1 and L2 between current locations P2 and P3 and a destination P1. Specifically, when the distance L2 between the current location P3 and the destination P1 is long, that is, when the current location P3 and the destination P1 are far from each other, an error θ2 in azimuth angle due to the error in position is small. In contrast, when the distance L1 between the current location P2 and the destination P1 is short, that is, when the current location P2 and the destination P1 are close to each other, an error θ1 in azimuth angle due to the error in position is great.

In this way, as a distance between a current location and a destination is shorter, an error in azimuth angle due to an error in position appears more greatly. In other words, magnitude of an error in azimuth angle due to an error in position can be indicated by increasing an angle of a reciprocating hand movement of the pointer 13 as the user approaches a departure point being a destination, and the user can be informed that a deviation from an azimuth indicated by the pointer 13 is increased.

Note that the above description provides the example of displaying a distance to a destination by using the hour hand 11 and the minute hand 12 during the navigation operation, but the hour hand 11 and the minute hand 12 may indicate the current time even during the navigation operation, and, in this case, the time during the navigation operation can be informed. Also, in this way, a distance to a destination can be intuitively informed by reciprocating motion of the pointer 13.

1.2.3 Utilization of GPS

Next, a technique by the electronic watch W1 for acquiring coordinates of a current location and time information by using a radio wave from the GPS satellite 8, which is an example of an external signal, will be described with reference to FIG. 2.

The electronic watch W1 is a watch that receives a satellite signal from the GPS satellite 8 and corrects time of an RTC 1 described later serving as an internal clock. The electronic watch W1 displays time and the like on a surface on a side opposite to a surface on a side that contacts an arm. Note that, hereinafter, the surface on the side that contacts the arm is referred to as a “back surface”, and the surface on the side opposite to the back surface is referred to as a “front surface”. The GPS satellite 8 is a navigation satellite that makes a circuit in a predetermined orbit in the Earth's sky. The GPS satellite 8 transmits, to the ground, a radio wave being an L1 wave of 1.57542 GHz on which a navigation message is superimposed. In the following description, a radio wave of 1.57542 GHz on which a navigation message is superimposed is referred to as a satellite signal. The satellite signal is a circularly polarized wave of a right handed polarized wave.

About 31 GPS satellites 8 are currently present. Note that FIG. 2 illustrates only four GPS satellites 8. In order to identify which GPS satellite 8 a satellite signal is transmitted from, each of the GPS satellites 8 superimposes a unique pattern of 1023 bits, namely, 1 ms periods referred to as a coarse/acquisition code (C/A code) on a satellite signal. Each bit is either +1 or −1. Thus, the C/A code appears as a random pattern.

The GPS satellite 8 is equipped with an atomic clock. A satellite signal includes extremely accurate GPS time information that is timed by the atomic clock. A slight time error of the atomic clock mounted on each of the GPS satellites 8 is measured by a ground control segment. The satellite signal also includes a time correction parameter for correcting the time error. The electronic watch W1 receives a satellite signal being a radio wave transmitted from one GPS satellite 8, and matches timed time of the RTC 1 as the internal clock with correct time acquired by using the GPS time information and the time correction parameter included in the satellite signal.

The satellite signal also includes orbital information indicating a position of the GPS satellite 8 in orbit. The electronic watch W1 can perform a positioning calculation by using the GPS time information and the orbital information. The positioning calculation is performed assuming that a certain amount of error is included in timed time of the internal clock of the electronic watch W1. In other words, in addition to x, y, and z parameters for identifying a three-dimensional position of the electronic watch W1, a time error is also unknown. Thus, the electronic watch W1 generally receives a satellite signal transmitted from each of four or more GPS satellites 8, performs a positioning calculation by using GPS time information and orbital information included in the satellite signal, and determines coordinates of a current location as positional information about the current location. The satellite signal is an example of positional identification information for identifying a position of a current location.

1.3 Time Display Mode

When the operation mode is the time display mode, the time display unit 10 displays time with the hour hand 11 and the minute hand 12 with reference to the scale 14a. Pointing positions of the hour hand 11 and the minute hand 12 are changed according to an operation of the crown switch D, for example. The pointer 13 can function as a seconds hand in the time display mode.

Further, in the time display mode, when the user presses the start switch B, a chronograph function is enabled, and the time display unit 10 displays time timed by a stopwatch function with the pointer 13. Note that the chronograph function can be referred to as a stopwatch function.

Further, when the operation mode is the navigation mode, the time display unit 10 points to a direction of a destination with the pointer 13, and displays a distance to the destination with the hour hand 11 and the minute hand 12 with reference to the scale 14b. At this time, each numerical value on the scale 14b is used as a value of a digit in the one's place of “km” for the hour hand 11, and is used as a value of a digit in the hundred's place of “m” for the minute hand 12. In the example illustrated in FIG. 1, the hour hand 11 points to “10” and the minute hand 12 points to “1.8” between “1” and “2”, and thus 10.18 km is displayed as a distance to a destination, namely, a remaining distance to the destination.

The six o'clock-side information display unit 20 displays that the operation mode is the time display mode by pointing to the letter 21a of “TIME” with the mode pointer 22. Further, the six o'clock-side information display unit 20 displays that the operation mode is the compass mode by pointing to the letter 21b of “CMP” with the mode pointer 22. Further, the six o'clock-side information display unit 20 displays that the operation mode is the navigation mode by pointing to the letter 21c of “NAVI” with the mode pointer 22.

The date display unit 50 includes a date indicator 51 that displays a date of a calendar.

To elaborate on FIG. 1 herein, the time display unit 10 points to the letter 21c of “NAVI” with the mode pointer 22 in the six o'clock-side information display unit 20, and indicates a state during the navigation operation in which the operation is started by further continuously pressing the start switch B for a predetermined period of time or longer. During this navigation operation, the pointer 13 points to a direction of a departure point being a destination in navigation, and the hour hand 11 and the minute hand 12 display a distance to the departure point being the destination instead of time.

1.4 Functional Configuration of Electronic Watch

Next, a functional configuration of the electronic watch W1 will be described with reference to FIG. 3. Note that, in FIG. 3, the same configuration as that illustrated in FIG. 1 is denoted by the same reference sign.

The electronic watch W1 includes, as a configuration related to the time display unit 10, the hour hand 11, the minute hand 12, the pointer 13, train wheel mechanisms 201 and 202, a stepping motor 301, the stepping motor 302, a motor driver 401, and the motor driver 402. The motor driver 401 drives the stepping motor 301 to drive the hour hand 11 and the minute hand 12 via the train wheel mechanism 201.

The motor driver 402 drives the stepping motor 302 to drive the pointer 13 via the train wheel mechanism 202.

The electronic watch W1 includes, as a configuration related to the six o'clock-side information display unit 20, the mode pointer 22, a train wheel mechanism 203, a stepping motor 303, and a motor driver 403.

The motor driver 403 drives the stepping motor 303 to drive the mode pointer 22 via the train wheel mechanism 203.

The electronic watch W1 includes, as a configuration related to the date display unit 50, the date indicator 51, a train wheel mechanism 206, a stepping motor 306, and a motor driver 406. The motor driver 406 drives the stepping motor 306 to drive the date indicator 51 via the train wheel mechanism 206.

The electronic watch W1 further includes the real-time clock (RTC) 1, the GPS receiver 2, the magnetic sensor 3, the storage unit 4, and the control unit 5.

The RTC 1 times time by using a reference signal output from a crystal oscillator (not illustrated), for example.

The GPS receiver 2 receives a satellite signal transmitted from the GPS satellite 8. The GPS receiver 2 is an example of a reception unit that receives positional identification information for identifying a current location via an antenna.

The magnetic sensor 3 measures an azimuth. The magnetic sensor 3 detects a geomagnetic field, namely, the magnetic north.

The storage unit 4 is, for example, a non-transitory recording medium (non-transitory storage medium), and records a computer program.

The control unit 5 includes an information acquisition unit 501 that acquires destination information indicating a position of a destination. When the user presses the point registration switch A at the departure point, the information acquisition unit 501 performs a so-called position registration operation of acquiring coordinates of the departure point as position coordinates and holding the coordinates in the storage unit 4. The coordinates of the departure point having the position registered are used as coordinates of a destination in navigation as destination information.

The control unit 5 is, for example, a CPU, and achieves various functions by reading and executing a computer program stored in the storage unit 4. For example, the control unit 5 identifies position coordinates of a current location by using a satellite signal received by the GPS receiver 2. Further, the control unit 5 performs navigation to a departure point being a destination by using the hour hand 11, the minute hand 12, and the pointer 13.

1.5 Operation of Electronic Watch

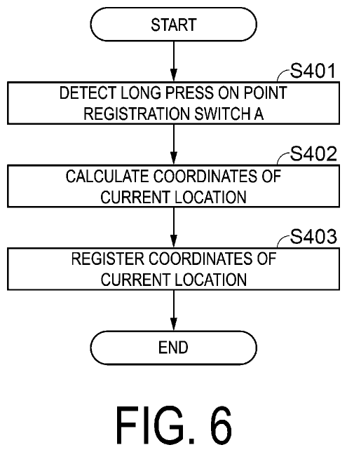

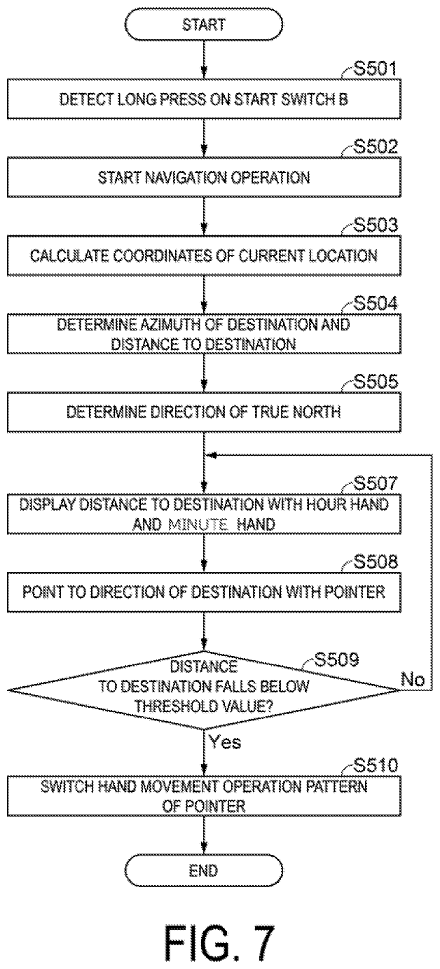

Next, an operation of the electronic watch W1 with a focus on the navigation mode will be described with reference to FIGS. 6 and 7. FIG. 6 is a flowchart illustrating a point registration operation of the electronic watch according to the first exemplary embodiment. FIG. 7 is a flowchart illustrating a navigation operation of the electronic watch according to the first exemplary embodiment.

1.5.1 Point Registration Operation

As illustrated in FIG. 6, when detecting that, for example, the point registration switch A is continuously pressed at a departure point for a specific period of time set to be, for example, two seconds or longer, that is, when detecting a long press on the point registration switch A (step S401), the information acquisition unit 501 of the control unit 5 activates the GPS receiver 2, and receives a satellite signal transmitted from the GPS satellite 8 via the GPS receiver 2. Next, the information acquisition unit 501 of the control unit 5 calculates coordinates of a current location being the departure point by using the satellite signal (step S402). When the calculation of the coordinates of the current location is successful, the control unit 5 stores (registers) the coordinates of the current location in the storage unit 4 (step S403). The coordinates stored in the storage unit 4 are used as destination information indicating a location of a destination. Note that, when the calculation of the coordinates of the current location fails, the control unit 5 terminates the point registration operation.

1.5.2 Navigation Operation

First, when detecting that the mode change switch C is pressed in a situation in which the operation mode is the time display mode, the control unit 5 switches the operation mode to the compass mode. Then, when detecting that the mode change switch C is pressed in the situation of the compass mode, the control unit 5 switches the operation mode to the navigation mode, and drives the motor driver 403 such that the mode pointer 22 points to the letter 21c of “NAVI”. Note that the navigation mode at this time is a standby state in which a navigation operation can be started.

Then, as illustrated in FIG. 7, in the navigation mode in this standby state, when detecting that the start switch B is continuously pressed for a predetermined period of time set to be, for example, five seconds or longer, that is, when detecting a long press on the start switch B in the navigation mode (step S501), the control unit 5 starts the navigation operation (step S502).

Next, the control unit 5 activates the GPS receiver 2, and receives a satellite signal transmitted from the GPS satellite 8 via the GPS receiver 2. Next, the control unit 5 calculates coordinates of a current location by using the satellite signal (step S503). Note that, when the calculation of the coordinates of the current location fails, the control unit 5 terminates the navigation operation.

Next, the control unit 5 uses the coordinates of the current location stored in the storage unit 4 as destination information, and identifies an azimuth of a destination viewed from the current location and a distance between the current location and a departure point, namely, a distance from the current location to the destination by using coordinates of the destination and the coordinates of the latest current location (step S504).

Next, the control unit 5 activates the magnetic sensor 3, and identifies a direction of the magnetic north, based on an output of the magnetic sensor 3. Next, the control unit 5 identifies a direction of the true north by correcting the direction of the magnetic north, based on information about declination previously stored in the storage unit 4 (step S505). Note that, when the storage unit 4 stores a declination table representing a relationship between declination and position coordinates, the control unit 5 may read declination corresponding to coordinates of a current location from the declination table, correct a direction of the magnetic north by using the read declination, and identify a direction of the true north.

Next, the control unit 5 controls the motor driver 401 such that the hour hand 11 and the minute hand 12 point to the distance from the current location to the destination (step S507). Next, the control unit 5 controls the motor driver 402 such that the pointer 13 points to a direction of the departure point being the destination in navigation (step S508). Herein, the control unit 5 identifies the direction of the destination, based on the azimuth of the destination and the direction of the true north.

Next, the control unit 5 compares the distance from the current location to the destination with a preset threshold value of a distance, and determines whether or not the distance from the current location to the destination the threshold value (step S509). When the control unit 5 determines that the distance from the current location to the destination

the threshold value from the determination (step S509: Yes), the control unit 5 switches the hand movement operation of the pointer 13 pointing to the direction of the destination to a preset hand movement operation (step S510).

The switched hand movement operation in the exemplary embodiment is a hand movement operation of causing a reciprocating hand movement of the pointer 13 in forward and reverse directions (see FIG. 1). Note that the hand movement operation is preset, is not limited to the reciprocating hand movement, and may be a hand movement operation different from a normal hand movement operation, such as a forward or reverse circling hand movement and a hand movement operation of rotating the pointer 13 once or continuously in a predetermined direction, for example. The electronic watch W1 notifies, by the reciprocating hand movement of the pointer 13, the user that the user approaches the destination within a predetermined distance. Note that the control unit 5 may terminate the navigation operation after performing the notification for a predetermined period of time, for example, one minute for power saving. Further, when the control unit 5 determines that the distance from the current location to the destination does not the threshold value (step S509: No), the control unit 5 continues the hand movement operation pattern of the pointer 13 pointing to the direction of the destination.

Note that the hand movement operation includes a plurality of hand movement operation patterns at different angles α, for example. The control unit 5 can switch a hand movement operation pattern among the plurality of hand movement operation patterns in accordance with a distance from a current location to a destination. Specifically, the control unit 5 has a plurality of threshold values set in accordance with a distance from a current location to a departure point being a destination in navigation, and can switch to a hand movement operation pattern of the pointer 13 corresponding to each of the threshold values when the distance from the current location to the destination each of the threshold values.

In this way, a hand movement operation pattern is switched to a hand movement operation pattern for each of a plurality of threshold values in accordance with a distance from a current location to a destination, and thus the user can be informed how close the user is to a departure point being a destination in navigation by the plurality of set threshold values by reading the hand movement operation pattern.

Hereinafter, while the navigation mode continues, the control unit 5 periodically performs calculation of coordinates of a current location by using a satellite signal, an identification operation of a direction of the true north by using an output of the magnetic sensor 3, an identification operation of a distance between the current location and a departure point by using destination information and the coordinates of the current location, and periodically updates display of a direction of a destination and a distance to the destination by using these results.

Note that, for power saving, when duration of the navigation operation exceeds a predetermined threshold period of time set to be, for example, two minutes, the control unit 5 stops the identification operation of the true north by using the magnetic sensor 3, the direction pointing operation by the pointer 13, and the distance display operation by the hour hand 11 and the minute hand 12, and changes a state to a standby state in which the time is displayed with the hour hand 11 and the minute hand 12. For example, when the duration of the navigation mode exceeds the predetermined threshold period of time, the control unit 5 may stop the navigation operation and force the navigation mode to change to the time display mode. The predetermined threshold period of time can be changed as appropriate without being limited to two minutes.

Further, as another method of power saving, calculation of coordinates of a current location by using a satellite signal may be performed only once, and only the identification operation of a direction of the true north by using an output of the magnetic sensor 3 may be performed periodically.

In this case, a distance to a destination is not updated, and a direction of the destination and a direction of the true north are periodically updated. This operation is sufficient when the user remains in the same position and only changes orientation.

According to the electronic watch W1 in the first exemplary embodiment described above, when a distance to an identified destination a threshold value, the control unit 5 switches the pointer 13 to a preset hand movement operation. In this way, the user can be intuitively informed that the user approaches or arrives at the destination, and the like by visually recognizing the switched hand movement operation of the pointer 13. In other words, the electronic watch W1 according to the present exemplary embodiment can intuitively inform the user that the user approaches or arrives at the destination, and the like by switching the hand movement operation of the pointer 13 performed in accordance with a numerical value of the distance.

### Second Exemplary Embodiment

2. Overview of Electronic Watch

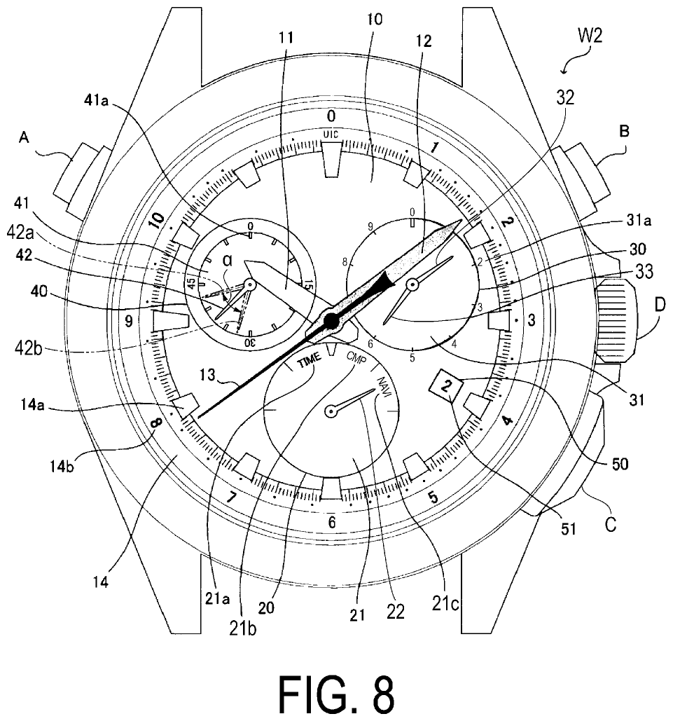

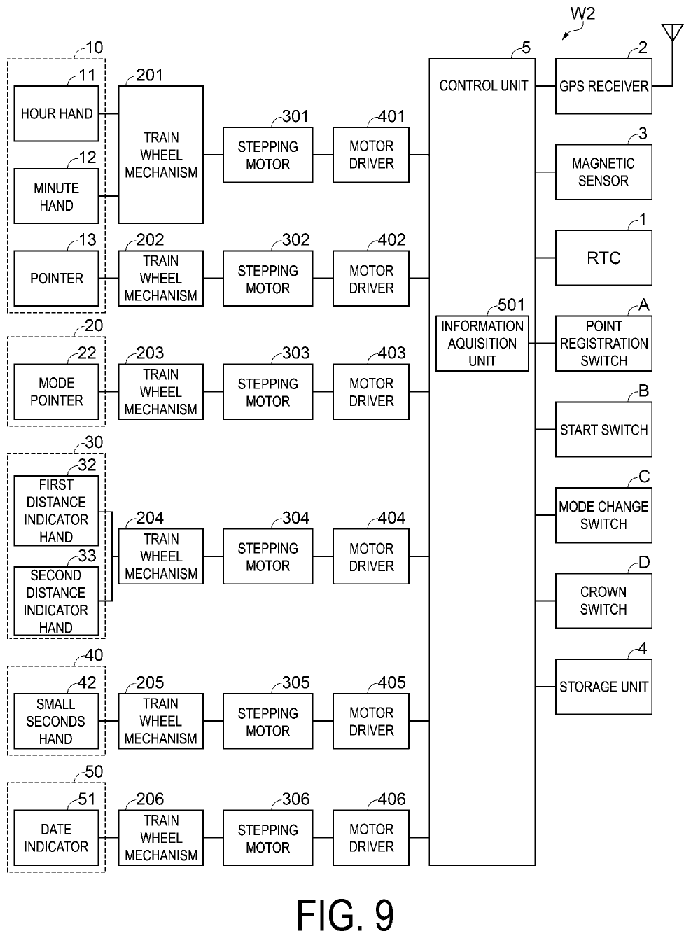

A configuration of an electronic watch according to a second exemplary embodiment will be described with reference to FIGS. 8 and 9.

The electronic watch according to the second exemplary embodiment is an electronic watch with a sensor, similarly to the first exemplary embodiment. Note that, hereinafter, the electronic watch with the sensor will be described as an “electronic watch”. FIG. 8 is a plan view illustrating the electronic watch according to the second exemplary embodiment. FIG. 9 is a functional block diagram of the electronic watch according to the second exemplary embodiment. Note that, in the following description, description of a configuration and a function similar to those of the electronic watch W1 according to the first exemplary embodiment may be omitted. Further, hereinafter, a “departure point” may be described in different words as a “destination in navigation” or simply a “destination”.

The electronic watch W2 according to the second exemplary embodiment includes, as operation modes, a compass mode for displaying an azimuth, a navigation mode for performing navigation to a destination, and a time display mode for displaying time, similarly to the first exemplary embodiment.

As illustrated in FIGS. 8 and 9, the electronic watch W2 according to the second exemplary embodiment includes a time display unit 10, a point registration switch A, a start switch B, a mode change switch C, and a crown switch D. The time display unit 10 includes an hour hand 11, a minute hand 12, a pointer 13, a dial ring 14, a six o'clock-side information display unit 20 provided on a six o'clock side, a two o'clock-side information display unit 30 provided on a two o'clock side, a 10 o'clock-side information display unit 40 provided on a 10 o'clock side, and a date display unit 50.

A 12-hour scale 14a is formed annularly on the dial ring 14, and a scale 14b of 0 to 10 is formed annularly on an outer side of the scale 14a. When the operation mode is the time display mode, the time display unit 10 displays time with the hour hand 11 and the minute hand 12 with reference to the scale 14a. Pointing positions of the hour hand 11 and the minute hand 12 are changed according to an operation of the crown switch D, for example.

The six o'clock-side information display unit 20 includes a dial 21 and a mode pointer 22. A letter representing an operation mode is provided on the dial 21 . Specifically, the dial 21 is provided with a letter 21a of “TIME” representing the time display mode, a letter 21b of “CMP” representing the compass mode, and a letter 21c of “NAVI” representing the navigation mode.

The two o'clock-side information display unit 30 includes a dial 31, and a first distance indicator hand 32 and a second distance indicator hand 33 as distance indicator hands. The two o'clock-side information display unit 30 displays a distance between a current location and a destination with the first distance indicator hand 32 and the second distance indicator hand 33.

The 10 o'clock-side information display unit 40 includes a dial 41 and a small seconds hand 42 as a pointer. A scale 41a for seconds is provided on the dial 41. When the operation mode is the time display mode, the 10 o'clock-side information display unit 40 displays seconds in time with the small seconds hand 42. Further, the 10 o'clock-side information display unit 40 displays an azimuth of a destination with the small seconds hand 42 during a navigation operation. In other words, the small seconds hand 42 is an example of a pointer indicating an azimuth of a destination.

The date display unit 50 includes a date indicator 51 that displays a date of a calendar.

2.1 Compass Mode

The electronic watch W2 can identify a north azimuth in the compass mode and display the identified north azimuth with the pointer 13. In the compass mode, the start switch B and the mode change switch C are used.

2.1.1 Overview of Azimuth Identification Operation

When a user presses the mode change switch C, the electronic watch W2 can switch the operation mode into the compass mode. In the compass mode, a compass operation is started by the user pressing the start switch B. Note that this azimuth identification operation is similar to that of the electronic watch W1 in the first exemplary embodiment described above, and thus description thereof will be omitted.

2.2 Navigation Mode

The electronic watch W2 can perform navigation for returning from a current location to a departure point being a destination, for example, in the navigation mode. For the navigation, the point registration switch A, the start switch B, and the mode change switch C are used.

2.2.1 Overview of Point Registration Operation

In the compass mode, when the user continues to press the point registration switch A at a departure point for a specific period of time or longer, the electronic watch W2 performs a so-called position registration operation of acquiring coordinates of the departure point as position coordinates and holding the coordinates. Note that this location registration operation is similar to that of the electronic watch W1 in the first exemplary embodiment described above, and thus description thereof will be omitted.

2.2.2 Overview of Navigation Operation

In the navigation operation, when the user moves to another point together with the electronic watch W2 after position setting of a departure point is performed by point registration, and the user then presses the mode change switch C, the operation mode of the electronic watch W2 switches. For example, when the user presses the mode change switch C in a case in which the operation mode is the time display mode, the operation mode switches to the compass mode. Furthermore, when the user presses the mode change switch C in the compass mode, the compass mode switches to the navigation mode, and a standby state in which the navigation operation can start is set. Then, when the start switch B is continuously pressed for a predetermined period of time or longer in this standby state, the electronic watch W2 starts the navigation operation. Note that the predetermined period of time for a long press on the start switch B may be, for example, five seconds, but can be changed as appropriate without being limited to five seconds.

During the navigation operation, the electronic watch W2 acquires coordinates of a current location once or periodically by the GPS, and periodically acquires a north direction by using the magnetic sensor 3 described later. Each time the electronic watch W2 acquires coordinates of a current location by the GPS, the electronic watch W2 calculates a direction to a destination and a distance from a current location to the destination by using coordinates of a departure point and the coordinates of the latest current location.

When calculating the direction of the destination and the distance to the destination, the electronic watch W2 performs navigation for returning to a departure point being the destination by pointing to a north direction acquired by using the magnetic sensor 3 with the pointer 13, pointing to the direction of the destination with reference to the north direction with the small seconds hand 42 as a pointer, and indicating the distance between the current location and the destination with the first distance indicator hand 32 and the second distance indicator hand 33 of the two o'clock-side information display unit 30.

Further, when calculating the direction of the destination and the distance to the destination, the electronic watch W2 displays the distance from the current location to the destination with the first distance indicator hand 32 and the second distance indicator hand 33 in the two o'clock-side information display unit 30. In the two o'clock-side information display unit 30 illustrated in FIG. 8, for example, the first distance indicator hand 32 constituted by a short hand indicates a higher order digit, and the second distance indicator hand 33 constituted by a long hand indicates a lower order digit. Specifically, in the example illustrated in FIG. 8, the first distance indicator hand 32 indicates 10 km, and the second distance indicator hand 33 indicates 6 km. In other words, in the example illustrated in FIG. 8, the distance between the current location and the destination is 16 km.

Then, when the distance to the destination a preset threshold value, that is, when the user approaches the destination within a predetermined distance, the electronic watch W2 switches the hand movement operation of the small seconds hand 42 as a pointer for displaying the direction of the destination. When the user approaches the destination within the predetermined distance, as illustrated in FIG. 8, for example, the electronic watch W2 switches the small seconds hand 42 to a hand movement operation of a reciprocating hand movement in forward and reverse directions between a line segment 42a and a line segment 42b, and causes the hand movement operation of the small seconds hand 42. The electronic watch W2 displays, to the user, that the user approaches the destination within the predetermined distance by switching the hand movement operation of the small seconds hand 42 to the reciprocating hand movement.

Note that the reciprocating hand movement of the small seconds hand 42 may include a plurality of hand movement operation patterns of hand movement operations at different angles α. Further, the hand movement operation of the small seconds hand 42 herein is not limited to the reciprocating hand movement, and the hand movement operation of the small seconds hand 42 may be a hand movement operation different from a normal hand movement operation, such as a forward or reverse circling hand movement and a fast-forward hand movement, for example.

Further, the electronic watch W2 has a plurality of threshold values set in accordance with a distance from a current location to a destination, and can switch the hand movement operation of the small seconds hand 42 to a hand movement operation pattern corresponding to each of the threshold values when the distance each of the threshold values. In other words, the electronic watch W2 includes a plurality of hand movement operation patterns set in accordance with a distance from a current location to a destination, and the plurality of hand movement operation patterns correspond to respective threshold values, thereby causing the hand movement operation of the small seconds hand 42. Herein, a hand movement operation pattern of the hand movement operation of the small seconds hand 42 is preset such that the hand movement operation is performed at a different angle α. Note that an example of switching to a hand movement operation pattern of the small seconds hand 42 by a plurality of threshold values is similar to the relationship between a plurality of threshold values set in accordance with a distance from a current location to a destination and a corresponding hand movement operation pattern, which is described in the first exemplary embodiment with reference to FIG. 4, and thus detailed description will be omitted.

The electronic watch W2 sets, for example, “1 km”, “500 m”, and “100 m” as threshold values related to a distance to a destination. Then, for example, when a distance to a destination

the threshold value of “1 km”, the electronic watch W2 causes, as a hand movement operation pattern corresponding to the threshold value, a reciprocating hand movement of the small seconds hand 42 at an angle α1=12 degrees with an azimuth position of the destination as the center. Further, for example, when the distance to the destination the threshold value of “500 m”, that is, when the user further approaches the destination, the electronic watch W2 causes, as a hand movement operation pattern corresponding to the threshold value, a reciprocating hand movement of the small seconds hand 42 at an angle α2=24 degrees with the azimuth position of the destination as the center. Further, for example, when the distance to the destination the threshold value of “100 m”, the electronic watch W2 causes, as a hand movement operation pattern corresponding to the threshold value, a greatly reciprocating hand movement of the small seconds hand 42 at an angle α3=36 degrees with the azimuth position of the destination as the center. In this way, by increasing a swinging angle of the reciprocating hand movement of the small seconds hand 42 as the user approaches the destination, the user can be informed about the extent of the distance to the destination. Note that the angle α1, the angle a2, and the angle α3 can be referred to as one-step width, a two-step width, and a three-step width, respectively.

Further, by performing the display as described above, the electronic watch W2 can also inform the user about a state of an error in azimuth of a destination caused by a GPS error by switching a hand movement operation pattern of the small seconds hand 42, similarly to the electronic watch W1 in the first exemplary embodiment described above. Note that detailed description thereof will be omitted.

2.2.3 Utilization of GPS

A technique by the electronic watch W2 for acquiring coordinates of a current location as positional information and time information by using a radio wave from the GPS satellite 8, which is an example of an external signal, is similar to that in the first exemplary embodiment described above, and thus description herein will be omitted.

2.3 Time Display Mode

When the operation mode is the time display mode, the time display unit 10 displays time with the hour hand 11 and the minute hand 12 with reference to the scale 14a. Pointing positions of the hour hand 11 and the minute hand 12 are changed according to an operation of the crown switch D, for example. Note that, when the operation mode is the time display mode, the pointer 13 is fixed to a 12 o'clock position.

Further, in the time display mode, when the user presses the start switch B, a chronograph function is enabled, and the time display unit 10 displays time timed by a stopwatch function with the pointer 13. Further, the chronograph function can be referred to as a stopwatch function.

The six o'clock-side information display unit 20 displays that the operation mode is the time display mode by pointing to the letter 21a of “TIME” with the mode pointer 22.

When the operation mode is the time display mode, the 10 o'clock-side information display unit 40 displays seconds in time with the small seconds hand 42.

The date display unit 50 includes the date indicator 51 that displays a date of a calendar.

To elaborate on FIG. 8 herein, the time display unit 10 points to the letter 21c of “NAVI” with the mode pointer 22 in the six o'clock-side information display unit 20, and indicates a state during the navigation operation in which the operation is started by further continuously pressing the start switch B for a predetermined period of time or longer. During this navigation operation, the small seconds hand 42 points to a direction of a departure point being a destination in navigation instead of seconds representing time, and the pointer 13 points to a north direction. Further, the hour hand 11 and the minute hand 12 display time.

2.4 Functional Configuration of Electronic Watch

Next, a functional configuration of the electronic watch W2 will be described with reference to FIG. 9. Note that, in FIG. 9, the same configuration as that illustrated in FIG. 8 is denoted by the same reference sign.

The electronic watch W2 includes, as a configuration related to the time display unit 10, the hour hand 11, the minute hand 12, the pointer 13, train wheel mechanisms 201 and 202, stepping motors 301 and 302, and motor drivers 401 and 402. The motor driver 401 drives the stepping motor 301 to drive the hour hand 11 and the minute hand 12 via the train wheel mechanism 201. The motor driver 402 drives the stepping motor 302 to drive the pointer 13 via the train wheel mechanism 202.

The electronic watch W2 includes, as a configuration related to the six o'clock-side information display unit 20, the mode pointer 22, a train wheel mechanism 203, a stepping motor 303, and a motor driver 403.

The motor driver 403 drives the stepping motor 303 to drive the mode pointer 22 via the train wheel mechanism 203.

The electronic watch W2 includes, as a configuration related to the two o'clock-side information display unit 30, the first distance indicator hand 32 as a distance indicator hand, the second distance indicator hand 33 as a distance indicator hand, a train wheel mechanism 204, a stepping motor 304, and a motor driver 404. The motor driver 404 drives the stepping motor 304 to drive the first distance indicator hand 32 and the second distance indicator hand 33 via the train wheel mechanism 204.

The electronic watch W2 includes, as a configuration related to the 10 o'clock-side information display unit 40, the small seconds hand 42, a train wheel mechanism 205, a stepping motor 305, and a motor driver 405. The motor driver 405 drives the stepping motor 305 to drive the small seconds hand 42 via the train wheel mechanism 205.

The electronic watch W2 includes, as a configuration related to the date display unit 50, the date indicator 51, a train wheel mechanism 206, a stepping motor 306, and a motor driver 406. The motor driver 406 drives the stepping motor 306 to drive the date indicator 51 via the train wheel mechanism 206.

The electronic watch W2 further includes a real-time clock (RTC) 1, a GPS receiver 2, a magnetic sensor 3, a storage unit 4, and a control unit 5.

The RTC 1 times time by using a reference signal output from a crystal oscillator (not illustrated), for example.

The GPS receiver 2 receives a satellite signal transmitted from the GPS satellite 8 via an antenna. The GPS receiver 2 is an example of a reception unit that receives positional identification information for identifying a current location.

The magnetic sensor 3 measures an azimuth. The magnetic sensor 3 detects a geomagnetic field, namely, the magnetic north.

The storage unit 4 is, for example, a non-transitory recording medium (non-transitory storage medium), and records a computer program.

The control unit 5 includes an information acquisition unit 501 that acquires destination information indicating a position of a destination. When the user presses the point registration switch A at the departure point, the information acquisition unit 501 performs a so-called position registration operation of acquiring coordinates of the departure point as position coordinates and holding the coordinates in the storage unit 4. The coordinates of the departure point having the position registered are used as coordinates of a destination in navigation as destination information.

The control unit 5 is, for example, a CPU, and achieves various functions by reading and executing a computer program stored in the storage unit 4. For example, the control unit 5 identifies position coordinates of a current location by using a satellite signal received by the GPS receiver 2. Further, the control unit 5 performs navigation to a departure point being a destination by using the first distance indicator hand 32 and the second distance indicator hand 33 of the two o'clock-side information display unit 30, the pointer 13, and the small seconds hand 42.

2.5 Operation of Electronic Watch

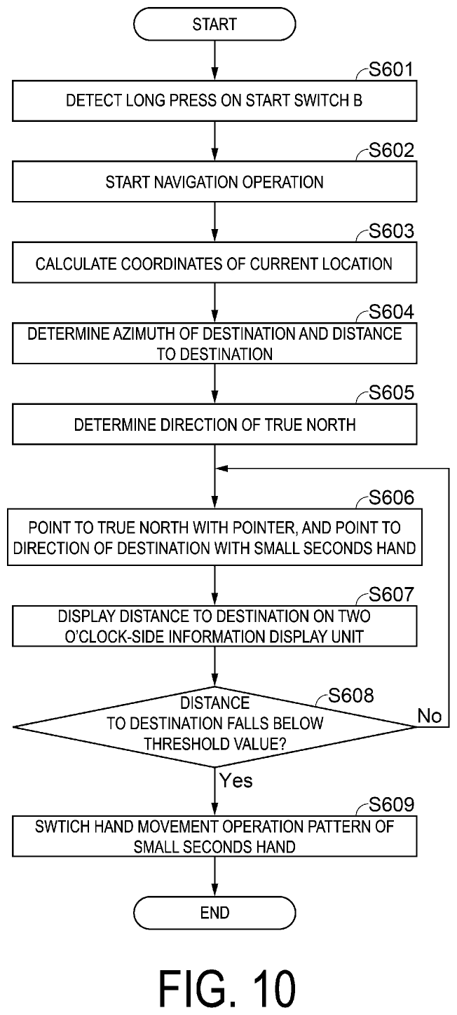

Next, an operation of the electronic watch W2 with a focus on the navigation mode will be described with reference to FIG. 10. FIG. 10 is a flowchart illustrating a navigation operation of the electronic watch according to the second exemplary embodiment. Note that a part of the operation of the electronic watch W2 described herein is performed in the same flow as the flow of the electronic watch W1 in the first exemplary embodiment described above with reference to FIG. 6.

2.5.1 Point Registration Operation

As illustrated in FIG. 6, when detecting that, for example, the point registration switch A is continuously pressed at a departure point for a specific period of time set to be, for example, two seconds or longer, that is, when detecting a long press on the point registration switch A (step S401), the information acquisition unit 501 of the control unit 5 activates the GPS receiver 2, and receives a satellite signal transmitted from the GPS satellite 8 via the GPS receiver 2. Next, the information acquisition unit 501 of the control unit 5 calculates coordinates of a current location being the departure point by using the satellite signal (step S402). When the calculation of the coordinates of the current location is successful, the control unit 5 stores (registers) the coordinates of the current location in the storage unit 4 (step S403). The coordinates stored in the storage unit 4 are used as destination information indicating a location of a destination. Note that, when the calculation of the coordinates of the current location fails, the control unit 5 terminates the point registration operation. By the way, the point registration operation is similar to that in the first exemplary embodiment.

2.5.2 Navigation Operation

First, when detecting that the mode change switch C is pressed in a situation in which the operation mode is the time display mode, the control unit 5 switches the operation mode to the compass mode. Then, when detecting that the mode change switch C is pressed in the situation of the compass mode, the control unit 5 switches the operation mode to the navigation mode, and drives the motor driver 403 such that the mode pointer 22 points to the letter 21c of “NAVI”. Note that the navigation mode at this time is a standby state of the navigation operation.

Then, as illustrated in FIG. 10, in this standby state, when detecting that the start switch B is continuously pressed for a predetermined period of time set to be, for example, five seconds or longer, that is, when detecting a long press on the start switch B in the navigation mode (step S601), the control unit 5 starts the navigation operation (step S602).

Next, the control unit 5 activates the GPS receiver 2, and receives a satellite signal transmitted from the GPS satellite 8 via the GPS receiver 2. Next, the control unit 5 calculates coordinates of a current location by using the satellite signal (step S603). Note that, when the calculation of the coordinates of the current location fails, the control unit 5 terminates the navigation operation.

Next, the control unit 5 uses the coordinates of the current location stored in the storage unit 4 as destination information, and identifies an azimuth of a destination viewed from the current location and a distance between the current location and a departure point, namely, a distance from the current location to the destination by using coordinates of the destination and the coordinates of the latest current location (step S604).

Next, the control unit 5 activates the magnetic sensor 3, and identifies a direction of the magnetic north, based on an output of the magnetic sensor 3. Next, the control unit 5 identifies a direction of the true north by correcting the direction of the magnetic north, based on information about declination previously stored in the storage unit 4 (step S605). Note that, when the storage unit 4 stores a declination table representing a relationship between declination and position coordinates, the control unit 5 may read declination corresponding to coordinates of a current location from the declination table, correct a direction of the magnetic north by using the read declination, and identify a direction of the true north.

Next, the control unit 5 controls the motor driver 402 such that the pointer 13 points to the direction of the true north, and controls the motor driver 405 such that the small seconds hand 42 as a pointer constituting the 10 o'clock-side information display unit 40 points to the direction of the departure point being the destination in navigation (step S606). Herein, the control unit 5 identifies the direction of the destination, based on the azimuth of the destination and the direction of the true north.

Next, the control unit 5 controls the motor driver 404 such that the first distance indicator hand 32 and the second distance indicator hand 33 as distance indicator hands constituting the two o'clock-side information display unit 30 display the distance between the current location and the destination (step S607).

Next, the control unit 5 compares the distance from the current location to the destination with a preset threshold value of a distance, and determines whether or not the distance from the current location to the destination the threshold value (step S608). When the control unit 5 determines that the distance from the current location to the destination

the threshold value from the determination (step S608: Yes), the control unit 5 switches the hand movement operation of the small seconds hand 42 as a pointer to a preset hand movement operation (step S609). The switched hand movement operation in the exemplary embodiment is a hand movement operation of causing a reciprocating hand movement of the small seconds hand 42 in forward and reverse directions (see FIG. 8). Note that the hand movement operation is preset, is not limited to the reciprocating hand movement, and may be a rotation movement that causes the small seconds hand 42 to rotate once in a predetermined direction, such as a forward rotation hand movement and a reverse rotation hand movement, for example. The electronic watch W2 notifies, by the reciprocating hand movement of the small seconds hand 42, the user that the user approaches the destination within a predetermined distance. Note that the control unit 5 terminates the navigation mode after performing the notification for a predetermined period of time, for example, one minute. Further, when the control unit 5 determines that the distance from the current location to the destination does not

the threshold value (step S608: No), the control unit 5 returns to the step of step S606.

Note that the hand movement operation according to the small seconds hand 42 includes a plurality of hand movement operation patterns at different angles α, for example. The control unit 5 can switch a hand movement operation pattern of the small seconds hand 42 among the plurality of hand movement operation patterns in accordance with a distance from a current location to a destination. Specifically, the control unit 5 has a plurality of threshold values set in accordance with a distance from a current location to a departure point being a destination in navigation, and can switch to a hand movement operation pattern of the small seconds hand 42 corresponding to each of the threshold values when the distance from the current location to the destination each of the threshold values.

In this way, a hand movement operation pattern of the small seconds hand 42 is switched to a hand movement operation pattern for each of a plurality of threshold values in accordance with a distance from a current location to a destination, and thus a user can be informed how close the user is to a departure point being a destination in navigation by the plurality of set threshold values by reading the hand movement operation pattern of the small seconds hand 42.

Hereinafter, while the navigation operation continues, the control unit 5 periodically performs calculation of coordinates of a current location by using a satellite signal, an identification operation of a direction of the true north by using an output of the magnetic sensor 3, an identification operation of a distance between the current location and a destination by using destination information and the coordinates of the current location, and periodically updates display of a direction of the destination, the direction of the true north, and a distance to the destination by using these results.

Note that, for power saving, when duration of the navigation operation exceeds a predetermined threshold time set to be, for example, two minutes, the control unit 5 stops the identification operation of the true north by using the magnetic sensor 3, the direction pointing operation by the small seconds hand 42 and the pointer 13, and the distance display operation by the first distance indicator hand 32 and the second distance indicator hand 33, and changes a state to a standby state in which the time is displayed with the hour hand 11 and the minute hand 12. For example, when the duration of the navigation mode exceeds the predetermined threshold period of time, the control unit 5 may stop the navigation operation and force the navigation mode to change to the time display mode. The predetermined threshold period of time can be changed as appropriate without being limited to two minutes.

Further, as another method of power saving, calculation of coordinates of a current location by using a satellite signal may be performed only once, and only the identification operation of a direction of the true north by using an output of the magnetic sensor 3 may be performed periodically.

In this case, a distance to a destination is not updated, and a direction of the destination and a direction of the true north are periodically updated. This operation is sufficient when the user remains in the same position and only changes orientation.

According to the electronic watch W2 in the second exemplary embodiment described above, when a distance to an identified destination a threshold value, the control unit 5 switches the small seconds hand 42 pointing to a direction of the destination to a preset hand movement operation pattern. In this way, the user can be intuitively informed that the user approaches or arrives at the destination, and the like by visually recognizing the switched hand movement operation of the small seconds hand 42. In other words, the electronic watch W2 according to the present exemplary embodiment can intuitively inform the user that the user approaches or arrives at the destination, and the like by switching the hand movement operation of the small seconds hand 42 in accordance with a numerical value of the distance.

### Third Exemplary Embodiment

3. Overview of Electronic Watch

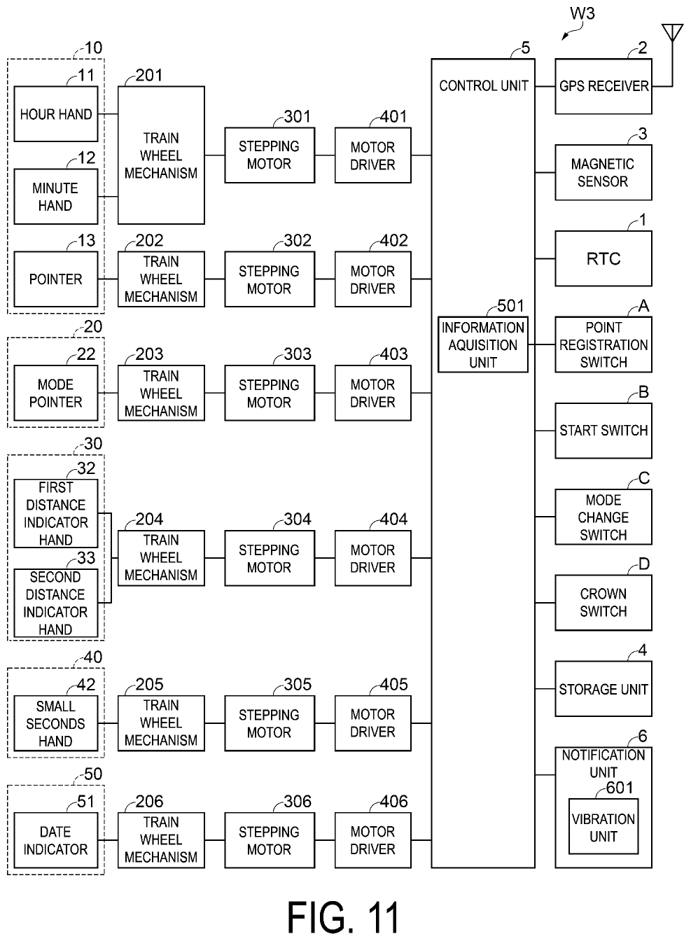

A configuration of an electronic watch according to a third exemplary embodiment will be described with reference to FIG. 11. The electronic watch according to the third exemplary embodiment is an electronic watch with a sensor, similarly to the second exemplary embodiment. Note that, hereinafter, the electronic watch with the sensor will be described as an “electronic watch”. FIG. 11 is a functional block diagram of the electronic watch according to the third exemplary embodiment. Herein, the electronic watch W3 according to the third exemplary embodiment has a configuration in which a notification unit 6 is provided in the electronic watch W2 according to the second exemplary embodiment, and an operation and a configuration other than this are similar to those of the electronic watch W2 in the second exemplary embodiment. Therefore, the notification unit 6, which is a different configuration, will be mainly described below with reference to FIG. 11, and description similar to that of the electronic watch W2 in the second exemplary embodiment will be omitted.

As illustrated in FIG. 11, the electronic watch W3 according to the third exemplary embodiment includes the notification unit 6 coupled to a control unit 5 in addition to the configuration of the electronic watch W2 according to the second exemplary embodiment. The notification unit 6 according to the present exemplary embodiment includes a vibration unit 601 constituted by a vibration motor and the like. The notification unit 6 can transmit vibration generated by driving the vibration unit 601 to a user via a case portion (not illustrated) of the electronic watch W3.

When a distance to an identified destination

a threshold value, the control unit 5 of the electronic watch W3 switches a small seconds hand 42 indicating a direction of the destination to a preset hand movement operation pattern, and also drives the vibration unit 601 and transmits the vibration to the user. In this way, the user can be informed that the user approaches or arrives at the destination, and the like from switching of the hand movement operation pattern of the small seconds hand 42 and the vibration transmitted from the case portion.

In this way, the electronic watch W3 according to the third exemplary embodiment can intuitively inform the user that the user approaches or arrives at the destination, and the like by visual perception caused by switching of a hand movement operation and a hand movement operation pattern of the small seconds hand 42 and sensory perception caused by vibration transmitted from the case portion in the notification unit 6.

Further, since the electronic watch W3 can inform that the user approaches or arrives at a destination by vibration, the user may not always gaze at a time display unit 10 and thus the usability can be improved.

Note that the notification unit 6 is not limited to the exemplified vibration unit 601, and may be, for example, a light emitting unit (not illustrated) that transmits information to a user by emitting light, a sound output unit (not illustrated) that transmits information to a user by emitting sound such as voice, and the like. Further, the notification unit 6 may be provided with at least any of the vibration unit 601, the light emitting unit (not illustrated), and the sound output unit (not illustrated).

Further, in the third exemplary embodiment described above, the configuration acquired by adding the notification unit 6 to the configuration of the electronic watch W2 in the second exemplary embodiment is described, but the third exemplary embodiment is not limited thereto. A configuration acquired by adding the notification unit 6 to the configuration of the electronic watch W1 in the first exemplary embodiment may be used.

### Modification Example

In the above-described exemplary embodiments, after the point registration switch A is continuously pressed for a specific period of time or longer at a departure point, and the departure point is registered as a destination, navigation for returning to the departure point is performed. However, when the navigation for returning to a departure point is performed, the control unit 5 may register each of a plurality of points (way points) on a movement path of a user to the storage unit 4, use one of the plurality of registered points as a destination, and perform navigation to the departure point in the end while switching a point used as the destination according to a user operation.

For example, with all of coordinates of destinations registered in the storage unit 4 in the past being cleared, a user continuously presses the point registration switch A for a specified period of time or longer at each of a plurality of points on a movement path, and registers coordinates of each of the points (coordinates of each destination) to the electronic watchs W1, W2, and W3 in order. At this time, the control unit 5 assigns a number corresponding to the order in which the points are registered to the coordinates of each of the points, and stores the coordinates of the point assigned with the number in the storage unit 4.

As an example, the control unit 5 assigns a number “n” (n is an integer of one or greater) to coordinates of an n-th registered point, and stores the coordinates of the point assigned with the number “n” in the storage unit 4.

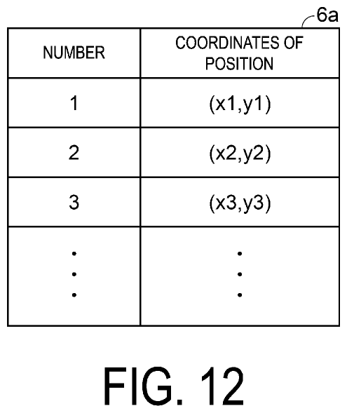

FIG. 12 is a diagram illustrating an example of a destination management table 6a for managing, by the storage unit 4, coordinates of a point assigned with a number. In this case, coordinates of each point (coordinates of each destination) registered before navigation starts are previously assigned with a number.

Note that, for example, when the point registration switch A and the start switch B are pressed together, the control unit 5 clears all point coordinates with numbers registered in the destination management table 6a illustrated in FIG. 12 (coordinates of destinations stored in the storage unit 4 in the past).

The control unit 5 uses one of a plurality of registered points as a destination, performs navigation to the destination, and, furthermore, controls the motor driver 406 such that the date indicator 51 displays a number (n) assigned to the coordinates of the point used as the destination.

For example, when a user registers coordinates of n points on one path in the storage units 4 of the electronic watchs W1, W2, and W3 in order, the control unit 5 first uses coordinates of the most recently registered point assigned with a number “n” as destination information about a destination, and displays “n” on the date indicator 51 while performing navigation to the point assigned with the number “n”. The date indicator 51 is an example of a number display unit that displays a number assigned to positional information used as destination information among a plurality of pieces of positional information.

Then, when determining that the user has returned to the point assigned with the number “n” according to the navigation of the electronic watchs W1, W2, W3, the user operates the start switch B and crown switch D, and switches, as the destination, the coordinates of the point assigned with the number “n” to coordinates of a point assigned with a number “n−1”. In response to the switching, the electronic watchs W1, W2, and W3 start navigation to the point assigned with the number “n−1”. Hereinafter, similarly, navigation for returning to a departure point is performed by switching a destination such that a number displayed on the date indicator 51 is reduced by one. Note that the operation of the start switch B and the crown switch D can be exemplified by, for example, pressing the start switch B while the crown switch D is pulled out.

Note that, in the above-described exemplary embodiments, a GPS using the GPS satellite 8 as a positional information satellite included in a global navigation satellite system (GNSS) is exemplified and described, but this is merely an example. The global navigation satellite system may include other system such as Galileo (EU), GLONASS (Russia), BeiDou (China), and a positional information satellite that transmits a satellite signal, such as a stationary satellite, for example, SBAS, and a quasi-zenith satellite. In other words, a positioning system may be configured to acquire any one of date information, time information, positional information, and velocity information determined by processing a radio wave (wireless signal) from a positional information satellite including a satellite other than the GPS satellite 8. Note that the global navigation satellite system may be a regional navigation satellite system (RNSS).

The contents derived from the exemplary embodiments described above will be described as each aspect below.

Aspect 1

An electronic watch according to the aspect includes a pointer, a reception unit configured to receive positional identification information for identifying a current location, a magnetic sensor, and a control unit configured to acquire destination information indicating a position of a destination, identify a direction of the destination, based on the positional identification information, an output of the magnetic sensor, and the destination information, identify a distance to the destination, based on the positional identification information and the destination information, and display a direction of the destination with the pointer, where the control unit switches the pointer to a set hand movement operation when the identified distance a threshold value.

According to the aspect, when the distance to the identified destination a threshold value, the control unit switches the pointer to a set hand movement operation. In other words, the hand movement operation is switched in conjunction with information related to a numerical value being a changing distance to a destination. In this way, a user can be intuitively informed that the user approaches or arrives at the destination, and the like by visually recognizing the switched hand movement operation. In other words, the electronic watch according to the aspect can intuitively inform the user that the user approaches or arrives at the destination, and the like by switching the hand movement operation of the pointer.

Aspect 2

The electronic watch according to the above-described aspect further includes a distance indicator hand, and the control unit may display a distance to the destination with the distance indicator hand.

According to the aspect, the control unit displays a distance to the destination with the distance indicator hand, and thus a user can be intuitively informed about the distance to the destination by visually recognizing the display of the distance indicator hand.

Aspect 3

In the electronic watch according to the above-described aspect, the hand movement operation may be a forward or reverse reciprocating hand movement or a forward or reverse circling hand movement of the pointer.

According to the aspect, a user can be intuitively informed that the user approaches or arrives at the destination by visually recognizing a hand movement operation different from a normal hand movement operation, such as the reciprocating hand movement of the pointer and the forward or reverse circling hand movement.

Aspect 4

In the electronic watch according to the above-described aspect, the control unit may display, with the pointer, that a user approaches or arrives at the destination by switching the hand movement operation.

According to the aspect, the pointer whose hand movement operation is switched displays that the user approaches or arrives at the destination, and thus the user can be intuitively informed that the user approaches or arrives at the destination by visually recognizing the hand movement operation of a reciprocating hand movement, a forward rotation hand movement, or a reverse rotation hand movement of the pointer.

Aspect 5

In the electronic watch according to the above-described aspect, the hand movement operation may include a plurality of hand movement operation patterns, and the control unit may switch the hand movement operation pattern among the plurality of hand movement operation patterns in accordance with a distance from the current location to the destination.

According to the aspect, the hand movement operation pattern is switched among the plurality of hand movement operation patterns of the hand movement operation in accordance with a distance from the current location to the destination, and thus the user can be informed how close the user is to the destination by visually recognizing the hand movement operation pattern.

Aspect 6

In the electronic watch according to the above-described aspect, the control unit may have a plurality of threshold values set in accordance with a distance from the current location to the destination, and switch to the hand movement operation pattern corresponding to each of the threshold values.

According to the aspect, the hand movement operation pattern is switched to the hand movement operation pattern corresponding to each of the plurality of threshold values in accordance with a distance from the current location to the destination, and thus a user can be informed how close the user is to the destination by the plurality of set threshold values by reading the hand movement operation pattern.

Aspect 7

The electronic watch according to the above-described aspect further includes a notification unit, and the control unit may make a notification by the notification unit when the identified distance the threshold value.

According to the aspect, when the identified distance the threshold value, the control unit switches the hand movement operation of the pointer, and also performs notification by the notification unit. A user can be intuitively and reliably informed about a state in which the user approaches or arrives at a destination and the like by the switching of the hand movement operation and the notification by the notification unit.

Aspect 8

In the electronic watch according to the above-described aspect, the notification unit may be at least any of a sound output unit, a light emitting unit, and a vibration unit.

According to the aspect, a user can be sensorily informed that the user approaches or arrives at the destination by at least any of sound information by the sound output unit, light information by the light emitting unit, and vibration by the vibration unit.

What is claimed is:

1. An electronic watch, comprising:
a pointer;
a receiver configured to receive positional identification information for identifying a current location;
a magnetic sensor; and
a controller configured to acquire destination information indicating a position of a destination, identify a direction of the destination based on the positional identification information, an output of the magnetic sensor, and the destination information, identify a distance to the destination based on the positional identification information and the destination information, and switch an operation of the pointer to a preset hand movement operation when the distance becomes shorter than a threshold value.

2. The electronic watch according to claim 1, further comprising
a distance indicator hand, wherein
the distance indicator hand displays a distance to the destination.

3. The electronic watch according to claim 1, wherein
the hand movement operation is a reciprocating hand movement or a circling hand movement of the pointer.

4. The electronic watch according to claim 2, wherein
the hand movement operation is a reciprocating hand movement or a circling hand movement of the pointer.

5. The electronic watch according to claim 1, wherein
the controller switches the hand movement operation when a user approaches or arrives at the destination.

6. The electronic watch according to claim 2, wherein
the controller switches the hand movement operation when a user approaches or arrives at the destination.

7. The electronic watch according to claim 3, wherein
the controller switches the hand movement operation when a user approaches or arrives at the destination.

8. The electronic watch according to claim 1, wherein
the hand movement operation includes a plurality of hand movement operation patterns, and
the controller switches among the plurality of hand movement operation patterns in accordance with a distance from the current location to the destination.

9. The electronic watch according to claim 2, wherein
the hand movement operation includes a plurality of hand movement operation patterns, and
the controller switches among the plurality of hand movement operation patterns in accordance with a distance from the current location to the destination.

10. The electronic watch according to claim 3, wherein
the hand movement operation includes a plurality of hand movement operation patterns, and
the controller switches among the plurality of hand movement operation patterns in accordance with a distance from the current location to the destination.

11. The electronic watch according to claim 4, wherein
the hand movement operation includes a plurality of hand movement operation patterns, and
the controller switches among the plurality of hand movement operation patterns in accordance with a distance from the current location to the destination.

12. The electronic watch according to claim 8, wherein
the controller has a plurality of threshold values set in accordance with a distance from the current location to the destination, and switches to the hand movement operation pattern corresponding to each of the threshold values.

13. The electronic watch according to claim 1, further comprising
a notification unit, wherein
the notification unit performs notification when the distance becomes shorter than the threshold value.

14. The electronic watch according to claim 2, further comprising
a notification unit, wherein
the notification unit performs notification when the distance becomes shorter than the threshold value.

15. The electronic watch according to claim 3, further comprising
a notification unit, wherein
the notification unit performs notification when the distance becomes shorter than the threshold value.

16. The electronic watch according to claim 5, further comprising
a notification unit, wherein
the notification unit performs notification when the distance becomes shorter than the threshold value.

17. The electronic watch according to claim 8, further comprising
a notification unit, wherein
the notification unit performs notification when the distance becomes shorter than the threshold value.

18. The electronic watch according to claim 13, wherein
the notification unit is at least any of a sound output unit, a light emitter, and a vibrator.

19. The electronic watch according to claim 14, wherein
the notification unit is at least any of a sound output unit, a light emitter, and a vibrator.

20. The electronic watch according to claim 15, wherein
the notification unit is at least any of a sound output unit, a light emitter, and a vibrator.
